(19) United States
(12) Patent Application Publication
(10) Pub. No.: US 2007/0175285 A1
(43) Pub. Date: Aug. 2, 2007

(54) Mini core in drilling samples for high resolution formation evaluation on drilling cuttings samples

(76) Inventor: Konstandinos Zamfes, Calgary (CA)

Correspondence Address: DIEDERIKS & WHITELAW, PLC, 12471 Dillingham Square, #301, Woodbridge, VA, 22192, US

(21) Appl. No.: 11/649,826

(22) Filed: Jan. 5, 2007

Related U.S. Application Data
(63) Continuation-in-part of application No. 10/711,467, filed on Sep. 20, 2004.
(60) Provisional application No. 60/481,447, filed on Sep. 30, 2003.

(51) Int. Cl. G01N 1/08

(52) U.S. Cl. 73/864.44; 73/864.45; 73/864.62

(57) ABSTRACT

An apparatus and method for mini core in drilling samples accumulated in the cups by sample catcher. It allows the explorations to obtain high resolution formation evaluation on drilling cuttings samples. The Mini Core apparatus consists of narrow tubular with a piston or cap. The thin wall tubular is rotated and/or vibrated and pressed in to the cup with wet sample of drilling cuttings. The piston or cap is placed after the desired depth of sample is reached and the vacuum is reestablished. The core is pulled out from the cup and then analyzed within the tubular or squeezed out on a flat tray for horizontal analysis. The micro layering can be visually separated, before they are mixed as in conventional sample and the information is lost.

### CROSS REFERENCE TO RELATED APPLICATIONS

This application is a continuation in part of U.S. Non-Provisional patent application Ser. No. 10/711,467 filed Sep. 20, 2004 which claims the benefit of priority of U.S. Provisional Patent Application No. 60/481,447 filed Sep. 30, 2003, which are incorporated herein by reference in their entirety.

### FIELD OF THE INVENTION

The present invention relates generally to methods and apparatus for evaluating the properties of a subsurface formation. More particularly, the present invention relates to methods and apparatus for obtaining a formation mini core in drilling samples for high resolution formation evaluation on drilling cuttings samples.

### BACKGROUND OF THE INVENTION

During the drilling of a well in a subsurface formation, mud or drilling fluid is circulated down hole and brings the drill cuttings of the strata penetrated being drilled. After the lag time, which comprises of the annular velocity and the depth of the well, the cuttings arrive to the surface. At the surface a sample catcher device, for example, such as that described in U.S. Pat. No. 6,386,026, may be used to capture the cuttings.

However, it is desirable to provide an improved method and apparatus for evaluating or storing the cuttings, for example captured as above, in a surface logging while drilling (SLWD) system.

### SUMMARY OF THE INVENTION

It is an object of the present invention to obviate or mitigate at least one disadvantage of previous methods and apparatus for evaluating or storing cuttings.

The present method and apparatus provides a mini core for drilling cutting samples accumulated in the cups by sample catcher. It allows the explorations to obtain high resolution formation evaluation on drilling cuttings samples.

The present method and apparatus may be used with samples collected using techniques known to one skilled in the art, for example the by a sample catcher as the one described in U.S. Pat. No. 6,386,026.

The apparatus and method of the present invention provide extraction of a mini core from a sample, for example the cup where the sample catcher accumulates the drilling cuttings samples. By analyzing the strata in sequentially stored cuttings the high resolution formation evaluation on drilling cuttings samples is achieved. This leaves the remaining material practically undisturbed and allows for additional mini core extraction if desired.

The mini core apparatus or the present invention provides a tubular container which is adapted to sealingly receive a piston or cap.

In one embodiment, the tubular is a relatively narrow cylinder, with open ends. The thin wall cylinder may be rotated, for example by hand to be pressed into the sample (for example in a cup containing a wet sample of drilling cuttings). Once the cylinder is placed into the sample to the desired depth, the piston or cap is sealingly placed in the exposed open end of the cylinder to establish a vacuum. The mini core may then be pulled out from the sample.

In another embodiment, the tubular has at least one face which is substantially planar, for example the tubular having a semi-circular cross-section or a polygon. Preferably, the cross section is a quadrilateral, for example a rectangle or square. Because such shapes can not be freely rotated as was the case with a cylinder, other means may be used to assist pressing the tubular into the sample, for example vibrations such as microvibrations or micropulses of relatively high frequency and low amplitude, which may be applied to the tubular using apparatus and methods known to one skilled in the art. Once the tubular is placed into the sample to the desired depth, the piston or cap is sealingly placed in the exposed open end of the tubular to establish a vacuum. The mini core may then be pulled out from the sample.

The tubular may have a magnification means, for example a lens either affixed with or adapted to operatively one or more of the planar sides.

The mini core may be stored or analyzed in the tubular. The mini core may be stabilized by the addition of a stabilizing material, such as a stabilizing fluid known to one skilled in the art, for example a solution containing sugar, to enhance long term storage.

Alternatively, the mini core may be removed from the tubular for analysis, for example by squeezing it out on a flat tray for horizontal analysis. The micro layering can be visually separated before they are mixed as in conventional sample and the information is lost.

In a first aspect, the present invention provides an apparatus for making a mini core from a sample for analysis, having a tubular having open ends, adapted for penetrating the sample to a selected depth; and a piston adapted for sealing at least one of the open ends when the selected depth is reached.

The tubular may preferably be cylindrical or a quadrilateral, such as a rectangle, square etc. Preferably, the sample contains drilling cuttings.

In further aspect, the present invention provides a method of making a mini core from a sample for analysis, comprising inserting an open ended tubular into the sample until a selected depth is reached; sealing the open ended tubular; and removing the tubular from the sample, pulling the mini core with it.

Preferably, a tubular such as a cylinder may be rotated to assist inserting the tubular into the sample. A tubular may be vibrated to assist inserting the tubular into the sample. Preferably, the sample contains drilling cuttings.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic cylindrical embodiment mini core apparatus of the present invention with a sample cup for extracting high resolution information of the drilled formation;

FIG. 2 is a cylindrical embodiment mini core apparatus of the present invention; and

FIG. 3 is a perspective drawing of a quadrilateral embodiment mini core apparatus of the present invention; and

FIG. 4 is a section of FIG. 3 along the lines 4-4 showing optional visualization means.

### DETAILED DESCRIPTION

Generally, the present invention provides a method and apparatus for gathering mini core samples of drill cuttings for a surface logging while drilling (SLWD) system, but is also applicable to mini core samples of other materials, such as discrete materials.

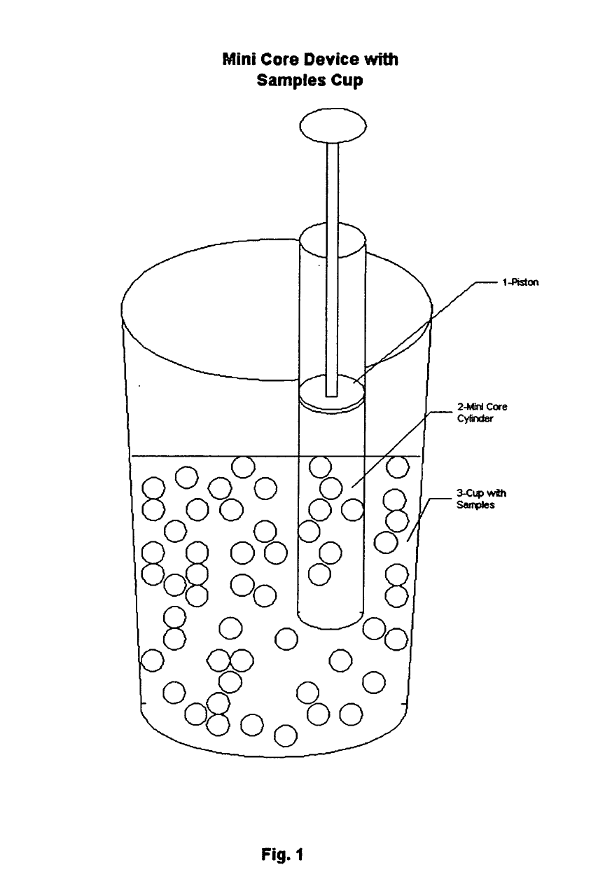

Referring to FIG. 1, a cylinder 2 is operatively associated with a piston 1. The cylinder 2 is thin wall cylinder is rotated, for example by hand and pressed into the cup 3 with wet sample of drilling cuttings. The piston 1 is placed into the cylinder 2 after the cylinder 2 is at the desired depth of sample to sealingly engage the cylinder 2 to re-establish a vacuum by sealing off the exposed opening of the cylinder 2. The core is pulled out from the cup 3 and may be analyzed in the cylinder 2 or squeezed out on a flat tray for horizontal analysis. The micro layering can be visually separated before they are disturbed or mixed and the information is lost.

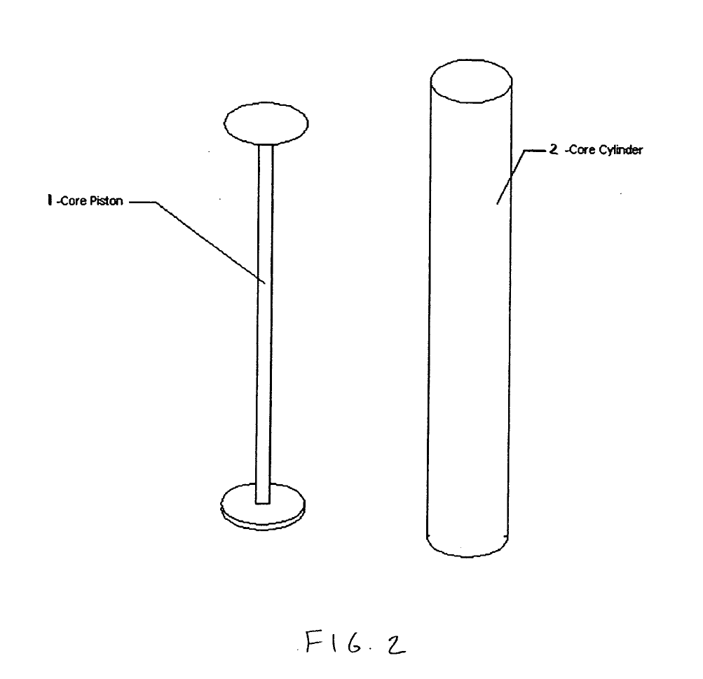

Referring to FIG. 2, the cylinder 2 and the piston 1 are shown in an exploded view.

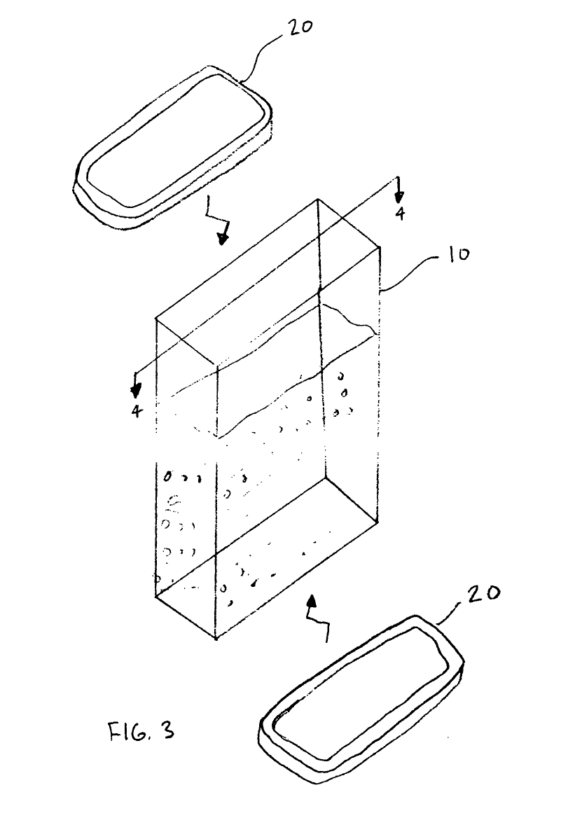

Referring to FIG. 3, a tubular 10, for example having a rectangular cross-section as shown is operatively associated with a cap 20. The tubular 10 is pressed or vibrated into the sample to a desired depth and the cap 20 is placed onto the tubular 10 to sealingly engage the tubular 10 to re-establish a vacuum by sealing off the exposed opening of the tubular 10. The core is pulled out from the sample and may be analyzed within the tubular 10 or may be squeezed out on a flat tray for horizontal analysis. For longer term storage the second cap 20 (FIG. 3) may be used to cover second end of embodiment.

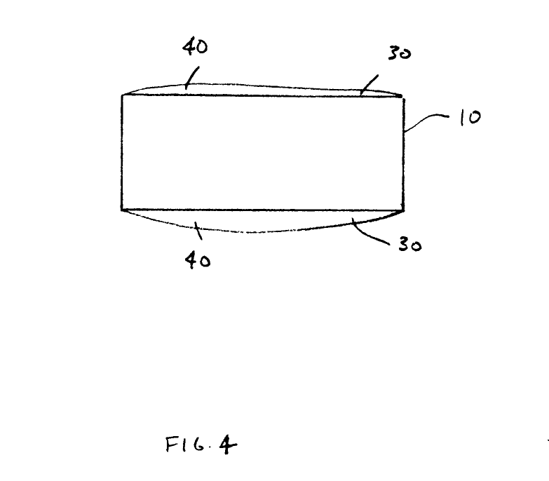

Referring to FIG. 4, a tubular 10 includes visualization means 30 associated with at least one side of the tubular 10 to enable improved analysis of the sample within the tubular, for example a measurement grid or measurement scale or magnification means in the form of a lens 40, as shown. While shown on two opposing faces, that is not required. The visualization means may differ from face to face or may be on some or all or none of the faces. Differing visualization means 30 may be on different faces, for example, a grid on one face, a measurement scale on another, and a lens 40 on another. The visualization means 30 may differ from one face to another, for example a lens 40 of magnification 2.0× may be on one face and a lens 40 of magnification 4.0× may be on another face.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. An apparatus for making a mini core from a sample for analysis, comprising:
a. a tubular having open ends, adapted for penetrating the sample to a selected depth; and
b. a piston adapted for sealing at least one of the open ends when the selected depth is reached.

2. The apparatus of claim 1, wherein the tubular is a cylinder.

3. The apparatus of claim 1, wherein the tubular is a quadrilateral.

4. The apparatus of claim 3, wherein the quadrilateral is a rectangle.

5. The apparatus of claim 1, the sample comprising drilling cuttings.

6. A method of making a mini core from a sample comprising:
c. inserting an open ended tubular into the sample until a selected depth is reached;
d. sealing at least one end of the open ended tubular; and
e. removing the tubular from the sample, pulling the mini core with it.

7. The method of claim 6, wherein the tubular is rotated to assist inserting the tubular into the sample.

8. The method of claim 6, wherein the tubular is vibrated to assist inserting the tubular into the sample.

9. The method of claim 6, the sample comprising drilling cuttings.
